(19) United States
(12) Patent Application Publication
(10) Pub. No.: US 2019/0329770 A1
(43) Pub. Date: Oct. 31, 2019

(54) SYSTEM AND METHOD FOR LANE LEVEL HAZARD PREDICTION

(71) Applicants: Honda Motor Co., Ltd., Tokyo (JP); The Regents of the University of California, Oakland, CA (US)

(72) Inventors: Samer Rajab, Novi, MI (US); Xue Bai, Novi, MI (US); Guoyuan Wu, Rancho Cucamonga, CA (US); Kanok Boriboonsomsin, Portland, OR (US); Matthew J. Barth, Riverside, CA (US); Fei Ye, Oakland, CA (US)

(21) Appl. No.: 15/981,222

(22) Filed: May 16, 2018

Related U.S. Application Data
(60) Provisional application No. 62/663,804, filed on Apr. 27, 2018.

(51) Int. Cl. B60W 30/095; H04W 4/46; G08G 1/16; B60W 30/09

(52) U.S. Cl. CPC B60W 30/0956; H04W 4/46; G08G 1/163; B60W 2550/20; B60W 30/09; B60W 2550/408; G08G 1/166

(57) ABSTRACT

A computer-implemented method for lane hazard prediction including receiving vehicle data from a plurality of vehicles each equipped for computer communication. Each vehicle in the plurality of vehicles is travelling along a road network including a plurality of lanes, and each lane in the plurality of lanes includes a plurality of lane level cells where each lane level cell includes a particular portion of a lane in the plurality of lanes. The method includes integrating the vehicle data into the plurality of lane level cells, and for each lane level cell in the plurality of lane level cells, calculating a probability that a hazard exists with respect to the lane level cell based on the vehicle data associated with the lane level cell, an adjacent upstream cell, and an adjacent downstream cell. Further, the method includes controlling a host vehicle based on the probability that the hazard exists downstream from the host vehicle.

### BACKGROUND

Lane level hazards such as lane closures, broken vehicles, collisions and/or debris on a road may cause significant delays and other issues for road users. Issues resulting from lane level hazards typically arise from a driver's inability to see the hazard from his/her lane beyond a certain surrounding of a host vehicle. This is particularly the case whenever the driver's vision is obstructed by large objects such as large vehicle or a vehicle backup operation. The driver's vision may also be reduced due to road geometry such as curvatures or certain weather conditions. Traditional sensory systems (e.g., radar, lidar, cameras) have limited detection range to the immediate surrounding of the host vehicle. As such, normally, the driver does not have information about obstructions ahead, neither at a road level nor at a lane level beyond the host vehicle's surrounding. Accordingly, a solution to predict hazard information at a lane level accurately is desirable.

### BRIEF DESCRIPTION

According to one aspect, a computer-implemented method for lane hazard prediction includes receiving vehicle data from a plurality of vehicles each equipped for computer communication. Each vehicle in the plurality of vehicles is travelling along a road network including a plurality of lanes, and each lane in the plurality of lanes includes a plurality of lane level cells where each lane level cell includes a particular portion of a lane in the plurality of lanes. The method includes integrating the vehicle data into the plurality of lane level cells. For each lane level cell in the plurality of lane level cells, the method includes calculating a probability that a hazard exists with respect to the lane level cell based on the vehicle data associated with the lane level cell, the vehicle data associated with an adjacent upstream cell, and the vehicle data associated with an adjacent downstream cell. Further, the method includes controlling a host vehicle based on the probability that the hazard exists downstream from the host vehicle.

According to another aspect, a system for lane hazard prediction, includes a plurality of vehicles each equipped for computer communication via a vehicle communication network. Each vehicle in the plurality of vehicles is travelling along a road network including a plurality of lanes, and each lane in the plurality of lanes includes a plurality of lane level cells where each lane level cell includes a particular portion of a lane in the plurality of lanes. The system includes a processor operatively connected for computer communication to the vehicle communication network, wherein the processor receives vehicle data transmitted from the plurality of vehicles, integrates the vehicle data into the plurality of lane level cells, and for each lane level cell in the plurality of lane level cells, calculates a probability that a hazard exists with respect to the lane level cell based on the vehicle data associated with the lane level cell, the vehicle data associated with an adjacent upstream cell, and the vehicle data associated with an adjacent downstream cell. Further, the processor controls a host vehicle based on the probability that the hazard exists downstream from the host vehicle.

According to a further aspect, a non-transitory computer-readable storage medium including instructions that when executed by a processor, causes the processor to receive vehicle data from a plurality of vehicles each equipped for computer communication. Each vehicle in the plurality of vehicles is travelling along a road network including a plurality of lanes, and each lane in the plurality of lanes includes a plurality of lane level cells, where each lane level cell includes a particular portion of a lane in the plurality of lanes. The instructions that when executed by the processor also cause the processor to integrate the vehicle data into the plurality of lane level cells, and for each lane level cell in the plurality of lane level cells, calculate a probability that a hazard exists with respect to the lane level cell based on the vehicle data associated with the lane level cell, the vehicle data associated with an adjacent upstream cell, and the vehicle data associated with an adjacent downstream cell. Further, the instructions that when executed by the processor also cause the processor to control a host vehicle based on the probability that the hazard exists downstream from the host vehicle.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary traffic scenario on a road network according to one embodiment;

FIG. 2 is a block diagram of an operating environment and systems for implementing lane level hazard prediction according to an exemplary embodiment;

FIG. 3 is a process flow diagram of a method for lane level hazard prediction according to an exemplary embodiment;

FIG. 4 is a time-space diagram of lane change maneuvers of vehicles according to an exemplary embodiment;

FIG. 5 is a diagram of relative conflict frequency at different penetration rates according to an exemplary embodiment;

FIG. 6 is a diagram of relative conflict frequency at different traffic volumes according to an exemplary embodiment;

FIG. 7 is a diagram of average speed increase at different penetration rates according to an exemplary embodiment; and

FIG. 8 is a diagram of average speed increase at different traffic volumes according to an exemplary embodiment.

### DETAILED DESCRIPTION

The following includes definitions of selected terms employed herein. The definitions include various examples and/or forms of components that fall within the scope of a term and that can be used for implementation. The examples are not intended to be limiting. Further, the components discussed herein, can be combined, omitted or organized with other components or into different architectures.

“Bus,” as used herein, refers to an interconnected architecture that is operably connected to other computer components inside a computer or between computers. The bus can transfer data between the computer components. The bus can be a memory bus, a memory processor, a peripheral bus, an external bus, a crossbar switch, and/or a local bus, among others. The bus can also be a vehicle bus that interconnects components inside a vehicle using protocols such as Media Oriented Systems Transport (MOST), Processor Area network (CAN), Local Interconnect network (LIN), among others.

“Component”, as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) can reside within a process and/or thread. A computer component can be localized on one computer and/or can be distributed between multiple computers.

“Computer communication”, as used herein, refers to a communication between two or more computing devices (e.g., computer, personal digital assistant, cellular telephone, network device, vehicle, vehicle computing device, infrastructure device, roadside device) and can be, for example, a network transfer, a data transfer, a file transfer, an applet transfer, an email, a hypertext transfer protocol (HTTP) transfer, and so on. A computer communication can occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication can utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Computer-readable medium,” as used herein, refers to a non-transitory medium that stores instructions and/or data. A computer-readable medium can take forms, including, but not limited to, non-volatile media, and volatile media. Non-volatile media can include, for example, optical disks, magnetic disks, and so on. Volatile media can include, for example, semiconductor memories, dynamic memory, and so on. Common forms of a computer-readable medium can include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Database,” as used herein, is used to refer to a table. In other examples, “database” can be used to refer to a set of tables. In still other examples, “database” can refer to a set of data stores and methods for accessing and/or manipulating those data stores. A database can be stored, for example, at a disk and/or a memory.

“Disk,” as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

“Input/output device” (I/O device) as used herein can include devices for receiving input and/or devices for outputting data. The input and/or output can be for controlling different vehicle features which include various vehicle components, systems, and subsystems. Specifically, the term “input device” includes, but it not limited to: keyboard, microphones, pointing and selection devices, cameras, imaging devices, video cards, displays, push buttons, rotary knobs, and the like. The term “input device” additionally includes graphical input controls that take place within a user interface which can be displayed by various types of mechanisms such as software and hardware based controls, interfaces, touch screens, touch pads or plug and play devices. An “output device” includes, but is not limited to: display devices, and other devices for outputting information and functions.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry can include and/or be a part of a processor controlled by an algorithm, a discrete logic (e.g., ASIC), an analog circuit, a digital circuit, a programmed logic device, a memory device containing instructions, and so on. Logic can include one or more gates, combinations of gates, or other circuit components. Where multiple logics are described, it can be possible to incorporate the multiple logics into one physical logic. Similarly, where a single logic is described, it can be possible to distribute that single logic between multiple physical logics.

“Memory,” as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

“Operable connection,” or a connection by which entities are “operably connected,” is one in which signals, physical communications, and/or logical communications can be sent and/or received. An operable connection can include a wireless interface, a physical interface, a data interface, and/or an electrical interface.

“Module”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

“Portable device”, as used herein, is a computing device typically having a display screen with user input (e.g., touch, keyboard) and a processor for computing. Portable devices include, but are not limited to, handheld devices, mobile devices, smart phones, laptops, tablets and e-readers.

“Processor,” as used herein, processes signals and performs general computing and arithmetic functions. Signals processed by the processor can include digital signals, data signals, computer instructions, processor instructions, messages, a bit, a bit stream, that can be received, transmitted and/or detected. Generally, the processor can be a variety of various processors including multiple single and multicore processors and co-processors and other multiple single and multicore processor and co-processor architectures. The processor can include logic circuitry to execute actions and/or algorithms.

“Vehicle,” as used herein, refers to any moving vehicle that is capable of carrying one or more human occupants and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” can refer to an electric vehicle (EV) that is capable of carrying one or more human occupants and is powered entirely or partially by one or more electric motors powered by an electric battery. The EV can include battery electric vehicles (BEV) and plug-in hybrid electric vehicles (PHEV). The term “vehicle” can also refer to an autonomous vehicle and/or self-driving vehicle powered by any form of energy. The autonomous vehicle can carry one or more human occupants. Further, the term “vehicle” can include vehicles that are automated or non-automated with pre-determined paths or free-moving vehicles.

“Vehicle display”, as used herein can include, but is not limited to, LED display panels, LCD display panels, CRT display, plasma display panels, touch screen displays, among others, that are often found in vehicles to display information about the vehicle. The display can receive input (e.g., touch input, keyboard input, input from various other input devices, etc.) from a user. The display can be located in various locations of the vehicle, for example, on the dashboard or center console. In some embodiments, the display is part of a portable device (e.g., in possession or associated with a vehicle occupant), a navigation system, an infotainment system, among others.

“Vehicle control system” and/or “vehicle system,” as used herein can include, but is not limited to, any automatic or manual systems that can be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, an interior or exterior camera system among others.

### I. System Overview

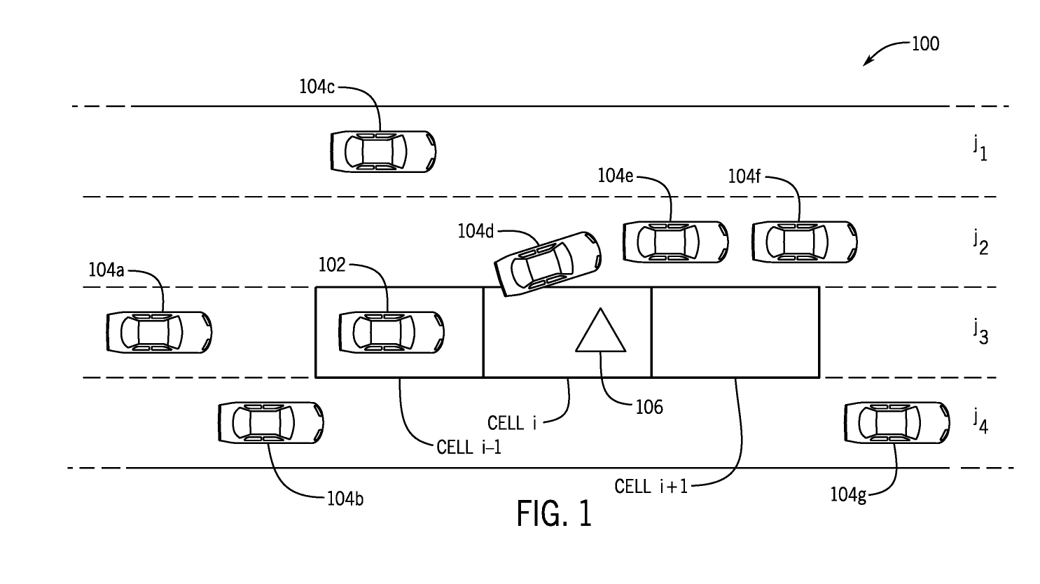

The systems and methods discussed herein are generally directed to using real-time information from remote vehicles (RVs) using vehicular communication (e.g., V2X) to provide lane level hazard prediction and vehicle control of a host vehicle (HV) and/or one more other RVs. Referring now to the drawings, wherein the showings are for purposes of illustrating one or more exemplary embodiments and not for purposes of limiting same, FIG. 1 is a schematic view of an exemplary traffic scenario on a road network 100 that will be used to describe lane hazard prediction according to one embodiment. The road network 100 can be any type of road, highway, freeway, or road segment. In FIG. 1, the road network 100 includes four lanes with the same travelling direction, namely, a lane j₁, a lane j₂, a lane j₃, and a lane j₄, however, it is understood that the road network 100 can have various configurations not shown in FIG. 1, and can have any number of lanes.

In FIG. 1, a plurality of vehicles (e.g., RVs) are travelling along the road network 100, namely, a host vehicle (HV) 102, a remote vehicle 104a, a remote vehicle 104b, a remote vehicle 104c, a remote vehicle 104d, and a remote vehicle 104e, a remote vehicle 104f, a remote vehicle 104g, although it is appreciated that any number of vehicles can be present on the road network 100. For purposes of illustration, each vehicle shown in FIG. 1 is equipped for computer communication as defined herein. However, it is understood that one or more of the vehicles may not be equipped for computer communication and/or not equipped with the lane hazard prediction methods and systems discussed herein. However, the methods and systems can perform lane hazard prediction based on the information from connected vehicles with a partial penetration rate.

As will be discussed herein, by crowd-sourcing information from remote vehicles equipped for computer communication, it is possible to extract features to detect an upcoming hazard downstream at a lane level, for example, the hazard 106 downstream from the HV 102. The term hazard, or hazardous condition, refers generally to one or more objects and/or driving scenarios that pose a potential threat to a vehicle. For example, in FIG. 1, the hazard 106 can indicate a lane closure, a disabled vehicle, a collision, and/or debris on the road network 100 that may cause significant delays and/or pose a potential threat downstream from a vehicle (e.g., the HV 102). Upon detecting the hazard 106 downstream from the HV 102, hazard information, lane recommendations, and/or semi-autonomous and fully autonomous responses can be provided to the HV 102.

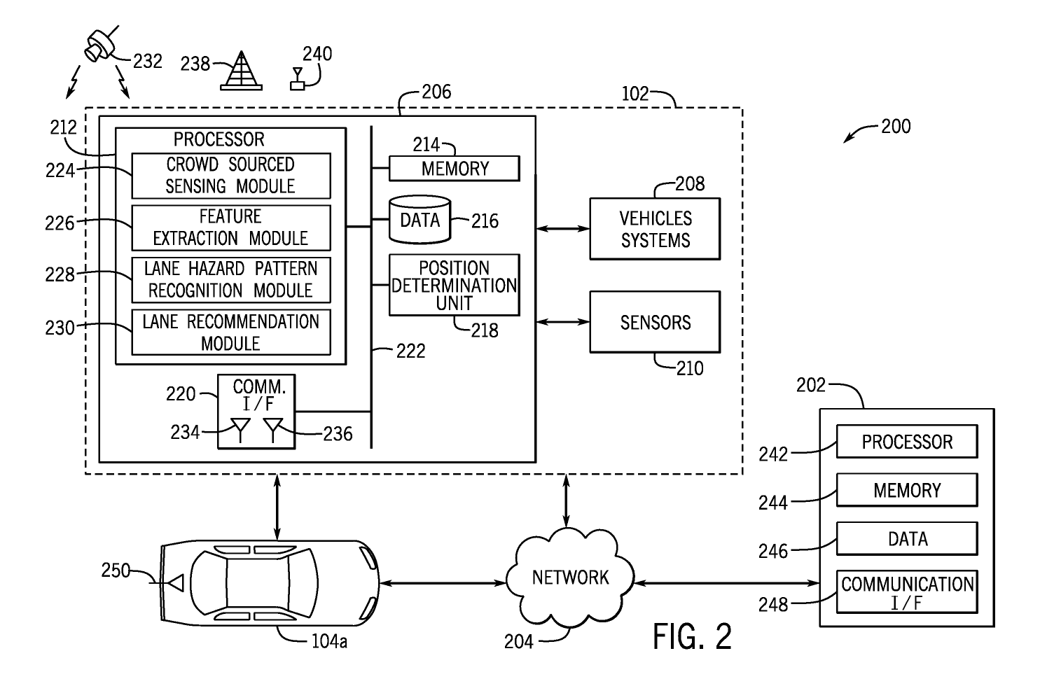

Referring now to FIG. 2, a schematic view of an operating environment 200 according to an exemplary embodiment is shown. One or more of the components of the operating environment 200 can be considered in whole or in part a vehicle communication network. In FIG. 2, a block diagram of the HV 102 is shown with a simplified block diagram of the RV 104a, a block diagram of a remote server 202, and a network 204. It is understood that the RV 104a, the RV 104b, the RV 104c, the RV 104d, the RV 104e, the RV 104f, the RV 104g, and/or the remote server 202 can include one or more of the components and/or functions discussed herein with respect to the HV 102. Thus, it is understood that although not shown in FIG. 2, one or more of the components of the HV 102, can also be implemented with that the RV 104a, the RV 104b, the RV 104c, the RV 104d, the RV 104e, the RV 104f, the RV 104g, and/or the remote server 202, other entities, traffic indicators, and/or devices (e.g., V2I devices, V2X devices) operable for computer communication with the HV 102 and/or with the operating environment 200. Further, it is understood that the components of the HV 102 and the operating environment 200, as well as the components of other systems, hardware architectures, and software architectures discussed herein, can be combined, omitted, or organized into different architectures for various embodiments.

In FIG. 2, the HV 102 includes a vehicle computing device (VCD) 206, vehicle systems 208, and sensors 210. Generally, the VCD 206 includes a processor 212, a memory 214, a data store 216, a position determination unit 218, and a communication interface (I/F) 220, which are each operably connected for computer communication via a bus 222 and/or other wired and wireless technologies defined herein. Referring again to the HV 102, the VCD 206, can include provisions for processing, communicating and interacting with various components of the HV 102 and other components of the operating environment 200, including the RV 104a and the remote server 202. In one embodiment, the VCD 206 can be implemented with the HV 102, for example, as part of a telematics unit, a head unit, an infotainment unit, an electronic control unit, an on-board unit, or as part of a specific vehicle control system, among others. In other embodiments, the VCD 206 can be implemented remotely from the HV 102, for example, with a portable device (not shown), a remote device (not shown), or the remote server 202, connected via the network 204.

The processor 212 can include logic circuitry with hardware, firmware, and software architecture frameworks for facilitating lane hazard prediction and control of the HV 102 and/or the RV 104a. Thus, in some embodiments, the processor 212 can store application frameworks, kernels, libraries, drivers, application program interfaces, among others, to execute and control hardware and functions discussed herein. For example, in FIG. 2, the processor 212 can include a crowd sourced sensing module 224, a feature extraction module 226, a lane hazard pattern recognition module 228, and a lane recommendation module 230, although it is understood that the processor 212 can be configured into other architectures. Further, in some embodiments, the memory 214 and/or the data store (e.g., disk) 216 can store similar components as the processor 212 for execution by the processor 212.

The position determination unit 218 can include hardware (e.g., sensors) and software to determine and/or acquire position data about the HV 102. For example, the position determination unit 218 can include a global positioning system (GPS) unit (not shown) and/or an inertial measurement unit (IMU) (not shown). Thus, the position determination unit 218 can provide a geoposition of the HV 102 based on satellite data from, for example, a global position source 232, or from any Global Navigational Satellite infrastructure (GNSS), including GPS, Glonass (Russian) and/or Galileo (European). Further, the position determination unit 218 can provide dead-reckoning data or motion data from, for example, a gyroscope, accelerometer, magnetometers, among other sensors (not shown). In some embodiments, the position determination unit 218 can be a navigation system that provides navigation maps and navigation information to the HV 102.

The communication interface 220 can include software and hardware to facilitate data input and output between the components of the VCD 206 and other components of the operating environment 200. Specifically, the communication interface 220 can include network interface controllers (not shown) and other hardware and software that manages and/or monitors connections and controls bi-directional data transfer between the communication interface 220 and other components of the operating environment 200 using, for example, the communication network 204.

More specifically, in one embodiment, the VCD 206 can exchange data and/or transmit messages with other compatible vehicles and/or devices via a transceiver 234 or other communication hardware and protocols. For example, the transceiver 234 can exchange data with the RV 104a via a transceiver 250. In some embodiments, the HV 102 and the RV 104a can exchange data (e.g., vehicle data as described herein) utilizing a wireless network antenna 238, roadside equipment (RSE) 240, and/or the communication network 204 (e.g., a wireless communication network), or other wireless network connections.

As mentioned above, in some embodiments, data transmission can be executed at and/or with other infrastructures and servers. For example, in FIG. 2, the VCD 206 can transmit and receive information directly or indirectly to and from the remote server 202 over the communication network 204. The remote server 202 can include a remote processor 242, a memory 244, data 246, and a communication interface 248 that are configured to be in communication with one another. Thus, in FIG. 2, the transceiver 234 can be used by the VCD 206 to receive and transmit information to and from the remote server 202 and other servers, processors, and information providers through the communication network 204. In alternative embodiments, a radio frequency (RF) transceiver 236 can be used to receive and transmit information to and from the remote server 202. In some embodiments, the VCD 206 can receive and transmit information to and from the remote server 202 including, but not limited to, vehicle data, traffic data, road data, curb data, vehicle location and heading data, high-traffic event schedules, weather data, or other transport related data. In some embodiments, the remote server 202 can be linked to multiple vehicles (e.g., the RV 104a), other entities, traffic infrastructures, and/or devices through a network connection, such as via the wireless network antenna 238, the road side equipment 240, and/or other network connections.

Referring again to the HV 102, the vehicle systems 208 can include any type of vehicle control system and/or vehicle described herein to enhance the HV 102 and/or driving of the HV 102. For example, the vehicle systems 208 can include autonomous driving systems, driver-assist systems, adaptive cruise control systems, lane departure warning systems, merge assist systems, freeway merging, exiting, and lane-change systems, collision warning systems, integrated vehicle-based safety systems, and automatic guided vehicle systems, or any other advanced driving assistance systems (ADAS). As will be described, one or more of the vehicle systems 208 can be controlled according the systems and methods discussed herein.

The sensors 210, which can be implemented with the vehicle systems 208, can include various types of sensors for use with the HV 102 and/or the vehicle systems 208 for detecting and/or sensing a parameter of the HV 102, the vehicle systems 208, and/or the environment surrounding the HV 102. For example, the sensors 210 can provide data about vehicles and/or hazards in proximity to the HV 102. For example, the sensors 210 can include, but are not limited to: acceleration sensors, speed sensors, braking sensors, proximity sensors, vision sensors, ranging sensors, seat sensors, seat-belt sensors, door sensors, environmental sensors, yaw rate sensors, steering sensors, GPS sensors, among others. It is also understood that the sensors 210 can be any type of sensor, for example, acoustic, electric, environmental, optical, imaging, light, pressure, force, thermal, temperature, proximity, among others.

Using the system and network configuration discussed above, lane level hazard prediction and vehicle control can be provided based on real-time information from vehicles using vehicular communication. Detailed embodiments describing exemplary methods using the system and network configuration discussed above will now be discussed in detail.

### II. Methods for Lane Hazard Prediction

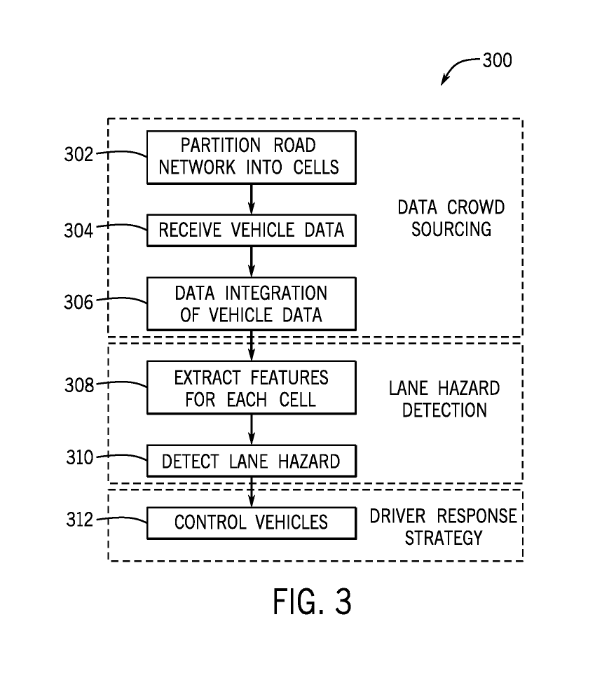

Referring now to FIG. 3, a method 300 for lane hazard prediction will now be described according to an exemplary embodiment. FIG. 3 will also be described with reference to FIGS. 1 and 2. As shown in FIG. 3, the method for lane hazard prediction can be described by three stages, namely, data crowdsourcing, lane hazard detection, and driver response strategy. For simplicity, the method 300 will be described by these stages, but it is understood that the elements of the method 300 can be organized into different architectures, blocks, stages, and/or processes.

### A. Data Crowdsourcing

At block 302, the method 300 includes partitioning a road network into cells. For example, the crowd sourced sensing module 224 can partition the road network 100 into the plurality of lane level cells. Referring to FIG. 1 and as described above, the road network 100 can include a plurality of lanes, namely, the lane j₁, the lane j₂, the lane j₃, and the lane j₄. Each lane can be partitioned into a plurality of lane level cells where each lane level cell includes a particular portion of the lane. Thus, the lane level cells can define a spatial domain of the road network 100 with respect to a longitudinal position in the lanes. In some embodiments, the road network 100 is partitioned into cells of an equal size, for example, 30 meters long in space by each lane.

In FIG. 1, three cells are shown in the lane j₃, specifically, cell i−1, cell i, and cell i+1. Cell i is referred to as the ego-cell, cell i−1 is an adjacent cell in an upstream direction from the ego-cell, and cell i+1 is an adjacent cell in a downstream direction from the ego-cell. It is understood that although only three cells are shown in FIG. 1, that each lane can be partitioned into a plurality of cells (e.g., more than three cells) and that the entire lane and/or road network 100 can be partitioned in this manner.

At block 304, the method 300 includes receiving vehicle data. For example, the crowd sourced sensing module 224 can receive vehicle data about one or more of the RVs travelling along the road network 100 (e.g., the HV 102, the RV 104a, the RV 104b, the RV 104c, the RV 104d, the RV 104e, the RV 104f, the RV 104g) using vehicular communication as described above with FIG. 2. Vehicle data can include speed, acceleration, velocity, yaw rate, steering angle, and throttle angle, range or distance data, among others. The vehicle data can also include course heading data, course history data, projected course data, kinematic data, current vehicle position data, and any other vehicle information about the RVs and the environment surrounding the RVs.

The crowd sourced sensing module 224 collects the vehicle data on spatial and temporal domains, and partitions (e.g., integrate) the vehicle data into the lane level cells (e.g., longitudinally) and into time slices (e.g., multiple of time steps). Accordingly, at block 306, the method 300 includes data integration of vehicle data into the plurality of lane level cells partitioned at block 302. In some embodiments, the data integration and temporal resolution is performed at a predetermined time interval, for example, 20 seconds.

### B. Lane Hazard Detection

Based on the crowdsourced vehicle data, at block 308, the method 300 includes extracting features (e.g., input features) for each lane level cell. In one embodiment, the feature extraction module 226 can extract and identify the key factors deemed to be representative for detecting a potential downstream hazard. For example, the features, which will be discussed in further detail herein, can include an average speed of the cell. The features can also include a vehicle maneuver of the cell. For example, in some embodiments, the feature extraction module 226 can identify a vehicle maneuver within each lane-level cell based on the vehicle data. The vehicle maneuver can be classified into five classes: through maneuver including both entry and leaving (M1), left lane change out (M2), right lane change out (M3), right lane change in (M4), left lane change in (M5).

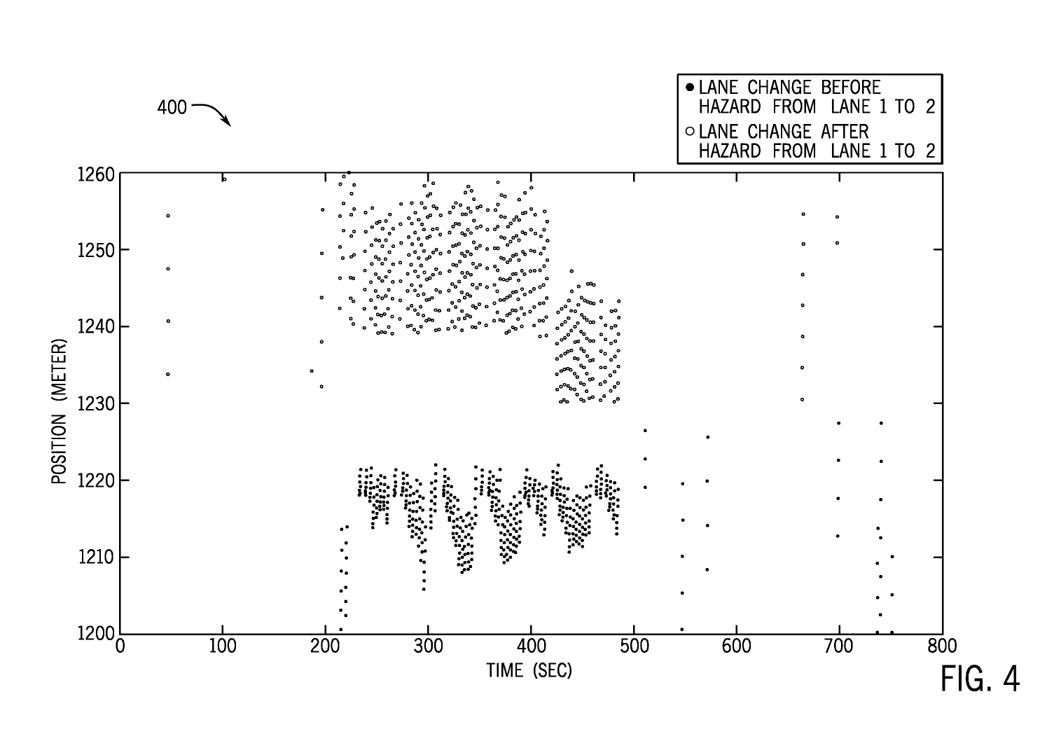

Using these features, the system can identify lane hazard patterns and detect lane hazards by the lane hazard pattern recognition module 228 at block 310. For example, with reference to the diagram 400 of FIG. 4, based on the vehicle data, patterns are observed that can identify collective behaviors for vehicle approaching a hazard location (e.g., the hazard 106). The diagram 400 visualizes lane change maneuvers for vehicles when a downstream hazard is present. In FIG. 4, the detected hazard occurs on a first lane at 1225 meters from the origin, which can be seen by a clear division of the lane change maneuver between the upstream and downstream of the hazard.

Accordingly, at block 310, the method 300 includes detecting a lane hazard. For example, for each lane level cell in the plurality of lane-level cells, the lane hazard pattern recognition module 228 calculates a probability that a hazard exists with respect to the lane level cell based on the vehicle data associated with the lane-level cell, the vehicle data associated with an adjacent upstream cell, and the vehicle data associated with an adjacent downstream cell. The lane hazard pattern recognition module 228 is executed locally for each lane level cell and outputs a binary hazard flag (1: hazard exist, 0: no hazard). Mathematically, for each cell (i, j) in the road network 100 (e.g., where i represents the longitudinal position and j indicates the lane number), measurements from the ego-cell and adjacent cells in the upstream and downstream segments are considered using a logistical regression shown in Equation (1) and Equation (2):

$$\begin{matrix}P ( y = 1 \vert x ) = {h}_{θ} ( x ) = \frac{1}{1 + exp ( - {θ}^{T} x )} & ( 1 ) \\ P ( y = 0 \vert x ) = 1 - P ( y = 1 \vert x ) = 1 - {h}_{θ} ( x ) & ( 2 )\end{matrix}$$

where, h_{θ}(x) is the probability of the hazard exist; θ is a vector of model parameters; x is a vector of feature input; and (y=0|1) represents the lane hazard flag for a particular lane level cell. The logic function constrains the values of landslide susceptibility index of the model in the range [0, 1]. In the embodiments discussed herein, the index threshold was set as 0.75. It is understood that although a logistical regression model is used throughout the methods and systems discussed herein, that any type of machine learning model can be implemented.

In one embodiment, eight input features (e.g., extracted at block 308) are applied to the algorithms shown in Equations (1) and (2), namely, average speed of cell (i, j); average speed of cell (i, j) over average speed of cell (i, j); average speed of cell (i, j) over average speed of cell (i−1,:); average speed of cell (i, j) over average speed of cell (i+1,:); #(M1) over the number of all the maneuvers; (#(M2)+#(M3)) over the number of all the maneuvers; and (#(M4)+#(M5)) over the number of all the maneuvers.

Equations (1) and (2) can be rewritten in an expanded form. Thus, the logistical regression discussed above can also be expressed mathematically as:

$$logit ( {P}_{ij} ) = ln ( \frac{{P}_{ij}}{1 - {P}_{ij}} ) = {β}_{0} + {β}_{1} \times {\overline{V}}_{ij} + {β}_{2} \times \frac{{\overline{V}}_{ij}}{{\overline{V}}_{i}} + {β}_{3} \times \frac{{\overline{V}}_{ij}}{{\overline{V}}_{i - 1}} + {β}_{4} \times \frac{{\overline{V}}_{ij}}{{\overline{V}}_{i + 1}} + {β}_{5} \times \frac{{m}_{1}}{m} + {β}_{6} \times \frac{{m}_{2} + {m}_{3}}{m} + {β}_{7} \times \frac{{m}_{4} + {m}_{5}}{m} + {β}_{8} \times {\sum }_{i = 1}^{n} \frac{{m}_{i}}{m} log ( \frac{{m}_{i}}{m} ) \qquad ( 3 )$$

Therefore, the probability that a hazard happened in each cell (i, j) can also be obtained by:

$${P}_{ij} = \frac{1}{1 + exp ( logit ( {P}_{ij} ) )} \qquad ( 4 )$$

where Pᵢⱼ is the probability that there is a hazard at cell (i, j); V̅ᵢⱼ is the average speed of cell (i, j); V̅ᵢ is the average speed across all the lanes at longitudinal segment I; V̅ᵢ₋₁ is the average speed of the lanes at cell (i, j) in the upstream adjacent longitudinal segment; V̅ᵢ₊₁ is the average speed of the lanes at cell (i, j) in the downstream adjacent longitudinal segment; mᵢ is the number of a vehicle maneuver (discussed below) that happened at cell (i, j), which belongs to predefined maneuver type i; m is the total number of maneuver happened at cell (i, j); n is the number of maneuver types; and βₖ represents the coefficients of the parameters. The parameter calibration results including the coefficients are shown in Table 1.

TABLE 1

| Var. | β₀ | β₁ | β₂ | β₃ | β₄ | β₅ | β₆ | β₇ | β₈ |
|---|---|---|---|---|---|---|---|---|---|
| Coeff. | −2.42 | −2.24 | −2.21 | −2.23 | −2.25 | −1.90 | 0.88 | −0.03 | −0.17 |

According to the embodiment in Equations (3) and (4), the eight input features can be summarized as: V̅ᵢⱼ is the average vehicle speed of cell (i, j);

$$\frac{{\overline{V}}_{ij}}{{\overline{V}}_{i}}$$

is the relative average speed ratio between cell (i, j) and all the lanes at the same longitudinal segment as cell (i, j);

$$\frac{{\overline{V}}_{ij}}{{\overline{V}}_{i - 1}}$$

is the relative average speed ratio between cell (i, j) and all the lanes at cell (i, j) upstream adjacent longitudinal segment;

$$\frac{{\overline{V}}_{ij}}{{\overline{V}}_{i + 1}}$$

is the relative average speed ratio between cell (i, j) and all the lanes at cell (i, j) upstream adjacent longitudinal segment;

$$\frac{{m}_{1}}{m}$$

is me percentage of throughput maneuver among the overall vehicle maneuvers;

$$\frac{{m}_{2} + {m}_{3}}{m}$$

is the percentage of lane change out of cell (i, j) over all the vehicle maneuvers;

$$\frac{{m}_{4} + {m}_{5}}{m}$$

is the percentage of lane change into cell (i, j) from its adjacent lanes over all the maneuvers; and

$${\sum }_{i = 1}^{n} \frac{{m}_{i}}{m} log ( \frac{{m}_{i}}{m} )$$

is the entropy measurement of the vehicle maneuvers.

With respect to the vehicle maneuvers, entropy of the vehicle maneuvers can be used as one of the feature inputs to capture the diversity of the maneuvers. The entropy attains its minimum value of zero when all the vehicles maneuvers are from the same categorized class and its maximum value when all the vehicles maneuvers are uniformly distributed. More specifically, the entropy of vehicle maneuvers is shown mathematically in Equation (5):

$$H = - {\sum }_{i = 1}^{n} \frac{{m}_{i}}{m} log ( \frac{{m}_{i}}{m} ) \qquad ( 5 )$$

### C. Driver Response Strategy

Based on the output of the models shown above, various driver response strategies can be executed using vehicle control. Accordingly, at block 312, the method 300 includes controlling one or more vehicles based on the lane hazard. For example, the lane recommendation module 230 can control one or more vehicle systems 208 based on the hazard 106 detected downstream of the travelling lane of the HV 102. For example, hazard information and/or lane choice suggestions can be provided to a human machine interface of the HV 102.

Additionally, semi-autonomous and fully autonomous responses can be provided to the HV 102. For example, control of lateral movement of the HV 102 (e.g., lane change to adjacent lane j₂ or adjacent lane j₄) can be performed when a hazard (e.g., hazard flag=1) is determined in the downstream of the current lane (e.g., lane j₃) of the HV 102. This control can also be performed based on a predetermined distance of the hazard 106, for example, when the hazard is detected within a communication range (e.g., 2000 meters) of the HV 102. Additionally, the upstream lane hazard prediction equipped vehicles on the other lanes can also be guided and/or controlled to not change lanes to the lane where the hazard 106 is present until they pass the hazard 106. It is understood that other types of control can also be implemented. For example, the speed of one or more of the RVs can be controlled in a cooperative manner to further smooth the detour behaviors of upstream traffic flow to minimize the impact of the hazard 106.

While the FIGS. 1, 2, and 3 are described with regard to the HV 102, the systems and methods can also function with respect to one or more of the remote vehicles. For example, in one embodiment, the RV 104a can act as a host vehicle. In such an embodiment, the HV 102 may act as a remote vehicle and the RV 104a receives early warnings as to potential lane hazards through the described methods.

For example, with respect to the method of FIG. 3, at block 302 the road network 100 is partitioned into cells by the crowd sourced sensing module 224 of the RV 104a. At block 304, the RV 104a receives vehicle data at the crowd sourced sensing module 224 about one or more of the remote vehicles including the HV 102. At block 306, the vehicle data is integrated into the plurality of lane level cells. Accordingly, the RV 104a receives and integrates data in a similar manner as any other vehicle on the road network 100 might.

At block 308, a feature extraction module 226 of the RV 104a identifies factors that are representative of a potential hazard that is downstream of the RV 104a. As described above, the factors may include the average speed of a cell, such as cell i−1 including the HV 102, which again, in this embodiment is a remote vehicle. The features might also include a maneuver of the HV 102 in cell i−1. At block 310, the lane hazard pattern recognition module 228 identifies lane hazard patterns to detect lane hazards. Then at block 312, the RV 104a can be controlled based on the detected lane hazard. For example, the RV 104a may change lanes to an adjacent lane. Accordingly, upstream vehicles can predict potential lane hazards downstream and maneuver to avoid them while not interrupting the flow of traffic.

### IV. Simulation and Results

The system and methods discussed herein were validated using a hypothetical road network in order to test general lane level maneuvers and hazard prediction. The hypothetical road network used was a two mile long freeway segment with four lanes. With the hypothetical road network, simulation tests were conducted under various V2X network penetration rates and different level traffic congestion levels. The detailed parameters used include V2X network based CV penetration rate (PR) and traffic volume. With respect to V2X network based CV PR, cellular network market penetration rate shows great promise with the long communication range, and reliability. A full penetration rate (i.e., 100%) enables lane hazard prediction to achieve accurate measurements, which leads to higher prediction accuracy and shorter reaction time. However, such an ideal case may not be achieved immediately, and the sensitivity analysis over different levels of penetration rate becomes meaningful. With respect to traffic volume, three different traffic congestion levels are considered. Specifically, light traffic (3000 veh/hr), moderate traffic (5000 veh/hr), and heavy traffic (7000 veh/hr) were tested in the simulation according to the number of vehicles released in the network within one hour simulation run.

In the simulation, lane hazard prediction equipped vehicles (e.g., vehicles equipped for computer communication and lane hazard prediction according to the systems and methods described herein) was set to 9% out of connected vehicles based on a V2X network. Therefore, there are three types of vehicles running in the simulation network, lane hazard prediction equipped vehicles, V2X-only vehicles, and conventional vehicles. Lane hazard prediction equipped vehicles are vehicles which can not only exchange information, but also change lanes to avoid a hazard in downstream traffic. V2X-only vehicles are vehicles that can exchange their real-time information (e.g., speed, lane level position) with other V2X network based connected vehicles, but without on-board applications. Conventional vehicles are vehicles without V2V communication ability and their behaviors follow the simulation software by-default lane and car following model. The simulation period for each run is set at 1800 seconds. For each combination of parameters of penetration rate and traffic volume (e.g., 50% V2X-equipped vehicles and 7000 veh/hr), the simulation ran ten (10) random seeds in the hypothetical road network.

With a driver response model (i.e., avoiding changing the lane where the downstream hazard is located), lane hazard prediction equipped vehicles can benefit from the application in terms of reducing aggressive lane change and smoothing the congestion propagation upstream of the hazard. Performance is evaluated by some surrogate measures, for example, a potential conflict, which is defined as an observable situation where two or more road users approach each other in space and time to such an extent that there is a risk of collision if their movements remain unchanged. Statistical analysis demonstrates the high correlation between conflicts and crashes. In this simulation, the conflict frequency obtained is chosen as the measurements for performance. The comparisons among lane hazard prediction equipped, unequipped and overall vehicles are quantified by the conflict frequency (CF) relative ratio, as defined below in Equation (6) and Equation (7).

$$\frac{{MOE}_{e} - {MOE}_{ue}}{{MOE}_{ue}} * 100 \% \qquad ( 6 )$$

where MOEₑ=the metric of equipped vehicles, CF caused by equipped vehicles; and MOEᵤₑ=the metric of unequipped vehicles, CF caused by unequipped vehicles.

$$\frac{{MOE}_{oa} - {MOE}_{bl}}{{MOE}_{bl}} * 100 \% \qquad ( 7 )$$

where MOEₒₐ=the metric of overall vehicles in high-speed differential warning equipped scenario, CF; and MOE_{bl}=the metric of overall vehicles in baselines, CF.

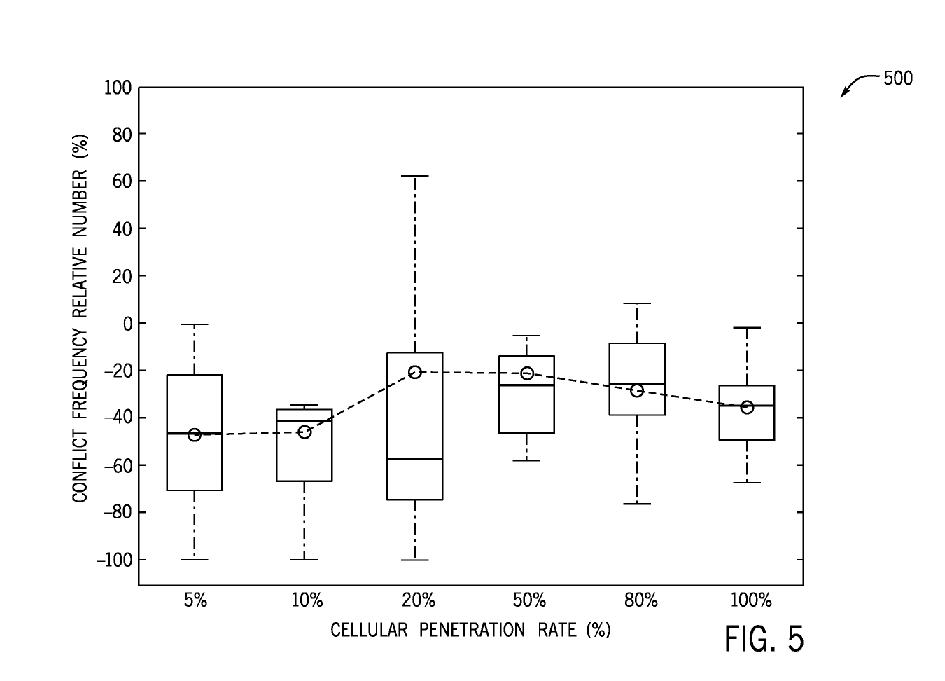

The boxplots and error bars of total conflict frequency (e.g., relative number) comparison between lane hazard prediction equipped vehicles and unequipped vehicles over different V2X connectivity penetration rates with traffic volume set at 7000 veh/hr as shown in diagram 500 of FIG. 5. As can be seen in the diagram 500, the average conflict frequency relative number are always negative over all the penetration rates, which implies a significant improvement for lane hazard equipped vehicles. The average conflict frequency reduction ranges from 21% to 47%. The potential reason is that triggering driver reaction in advance of hazard location can mitigate the shockwave impacts and smooth out the entire traffic flow.

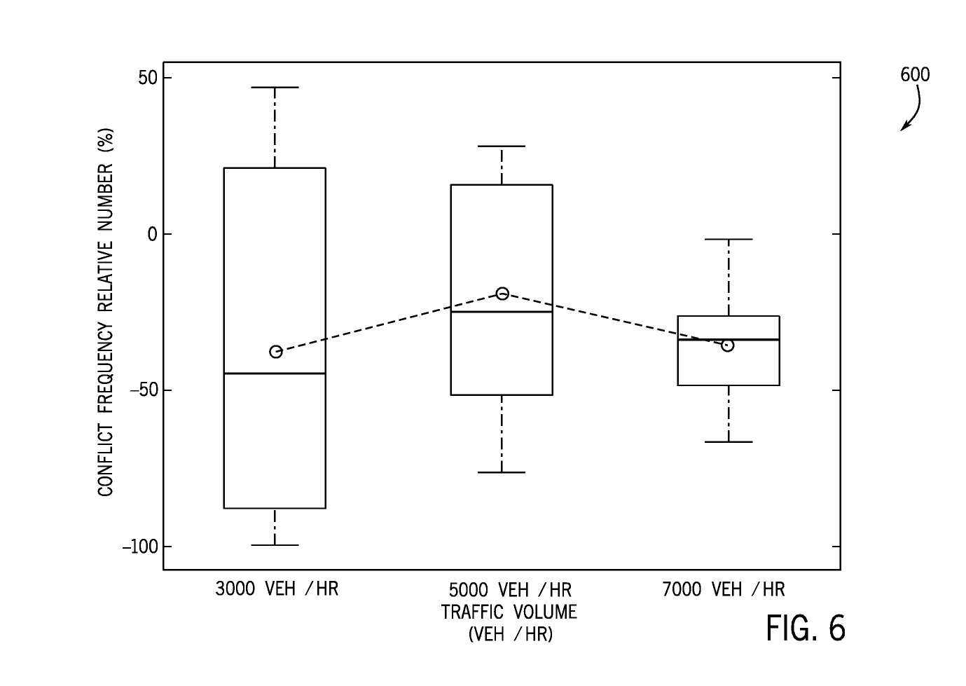

With reference now to FIG. 6, diagram 600 illustrates a traffic volume sensitivity analysis, which was conducted under the assumption of 100% V2X communication connectivity penetration rate and lane hazard prediction equipped vehicles is 9% out of the total V2X network based connected vehicles. As shown in diagram 600, the systems and methods for lane hazard prediction discussed herein have great potential to improve safety performance over different traffic congestion levels, including light traffic (e.g., 3000 veh/hr), moderate traffic (e.g., 5000 veh/hr) and heavy traffic (e.g., 7000 veh/hr). In particular, the average conflict frequency of lane hazard prediction equipped vehicles is reduced by 38%, 20%, 36% compared to unequipped vehicle for light, moderate and heavy traffic condition, respectively. However, in the heavy traffic condition, the benefit is more robust with less variance.

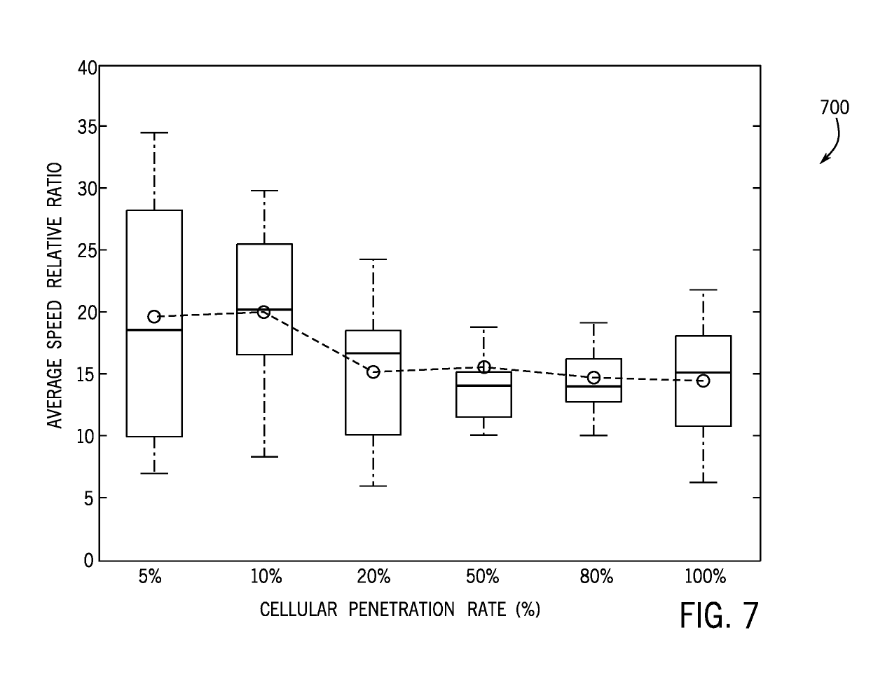

Mobility performance for lane hazard prediction vehicles, unequipped vehicles, and overall vehicles, was also observed using average speed according to Equation (8):

$$\overline{v} = \frac{{\sum }_{i = 1}^{n} {\sum }_{t = 1}^{{T}_{i}} {VMT}_{i , t}}{{\sum }_{i = 1}^{n} {\sum }_{t = 1}^{{T}_{i}} {VHT}_{i , t}} \qquad ( 8 )$$

where, VMT_{i,t}=vehicle miles traveled for vehicle i in timestep t, miles; and VHT_{i,t} is vehicle hours traveled for vehicle i in timestep t, hours. Diagram 700 shown in FIG. 7 shows the comparison results between lane hazard prediction equipped vehicles and unequipped vehicles on average speed (relative ratio). The average speed increase of lane hazard prediction equipped vehicles (15-20%) is significant over all the penetration rates and the improvement is more robust as the V2X communication connectivity penetration rate increases, which may be due to the prediction of hazard being more reliable and efficient.

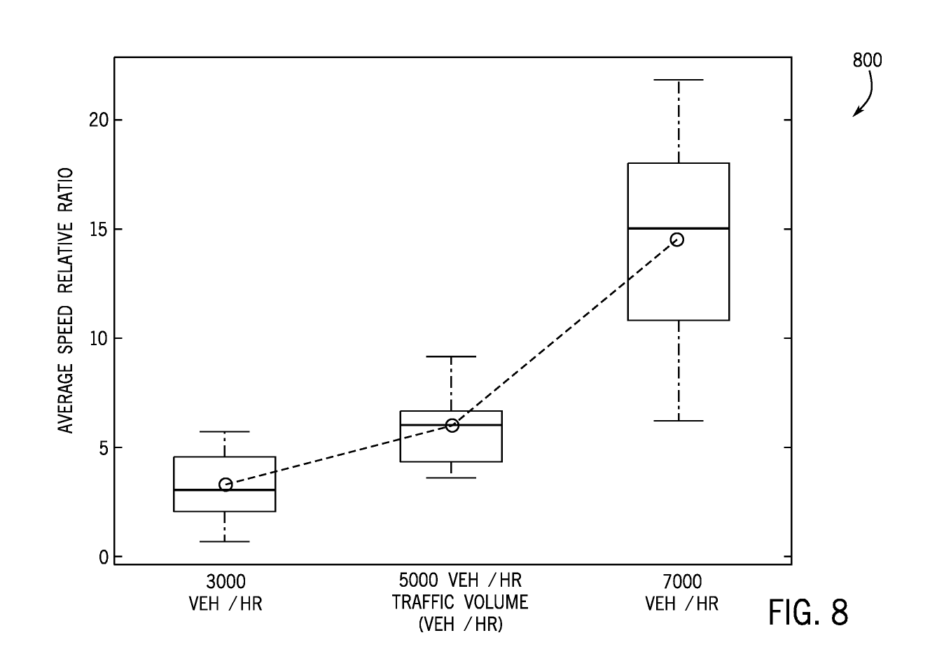

A traffic volume sensitivity analysis was also performed as shown in FIG. 8 and diagram 800. This analysis demonstrates that the average speed of lane hazard prediction equipped vehicles can increase by 3%, 6% and 15%, compared to unequipped vehicles (under 100% penetration rate) under light, moderate, and heavy traffic conditions. The mobility improvement in heavy traffic (i.e. 7000 veh/hr) is much more significant than that in light traffic, which may be a result of unequipped vehicles having more room to make a lane change right before approaching the hazard when the traffic is not so congested.

The embodiments discussed herein can also be described and implemented in the context of computer-readable storage medium storing computer executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data. Computer-readable storage media excludes non-transitory tangible media and propagated data signals.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for lane hazard prediction, comprising:
receiving vehicle data from a plurality of vehicles each equipped for computer communication, wherein each vehicle in the plurality of vehicles is travelling along a road network including a plurality of lanes, each lane in the plurality of lanes including a plurality of lane level cells, where each lane level cell includes a particular portion of a lane in the plurality of lanes;
integrating the vehicle data into the plurality of lane level cells;
for each lane level cell in the plurality of lane level cells, calculating a probability that a hazard exists with respect to the lane level cell based on the vehicle data associated with the lane level cell, the vehicle data associated with an adjacent upstream cell, and the vehicle data associated with an adjacent downstream cell; and
controlling a host vehicle based on the probability that the hazard exists downstream from the host vehicle.

2. The computer-implemented method of claim 1, including partitioning the road network into the plurality of lane level cells.

3. The computer-implemented method of claim 2, wherein the plurality of lane level cells are 30 meters long in space in each lane of the plurality of lanes.

4. The computer-implemented method of claim 1, including identifying a vehicle maneuver within each lane level cell based on the vehicle data.

5. The computer-implemented method of claim 4, wherein the vehicle maneuver within each lane level cell are classified as at least one of a through maneuver, a left lane change out, a right lane change out, a right lane change, and a left lane change in.

6. The computer-implemented method of claim 4, wherein calculating the probability that the hazard exists with respect to the lane level cell is based on an average speed of the lane level cell, an average speed of the lane level cell over an average speed of the adjacent upstream cell, an average speed of the lane level cell over an average speed of the adjacent downstream cell, and the vehicle maneuvers identified for the road network.

7. The computer-implemented method of claim 6, wherein the vehicle maneuvers identified for the road network is calculated based on an entropy of the vehicle maneuvers.

8. The computer-implemented method of claim 1, wherein calculating the probability that the hazard exists is based on a machine learning model of the vehicle data.

9. The computer-implemented method of claim 1, wherein controlling the host vehicle includes controlling a lane change of the host vehicle when the hazard is predicted in the downstream of a current travelling lane of the host vehicle.

10. A system for lane hazard prediction, comprising:
a plurality of vehicles each equipped for computer communication via a vehicle communication network, wherein each vehicle in the plurality of vehicles is travelling along a road network including a plurality of lanes, each lane in the plurality of lanes including a plurality of lane level cells, where each lane level cell includes a particular portion of a lane in the plurality of lanes; and
a processor operatively connected for computer communication to the vehicle communication network, wherein the processor:
receives vehicle data transmitted from the plurality of vehicles;
integrates the vehicle data into the plurality of lane level cells;
for each lane level cell in the plurality of lane level cells, calculates a probability that a hazard exists with respect to the lane level cell based on the vehicle data associated with the lane level cell, the vehicle data associated with an adjacent upstream cell, and the vehicle data associated with an adjacent downstream cell; and
controls a host vehicle based on the probability that the hazard exists downstream from the host vehicle.

11. The system of claim 10, wherein the processor partitions the road network into the plurality of lane level cells.

12. The system of claim 10, wherein the processor calculates the probability that the hazard exists is based on a logistic regression of the vehicle data.

13. The system of claim 12, wherein the vehicle data are input features extracted from each lane level cell and the input features include at least one of an average speed of the lane level cell, an average speed of the lane level cell over an average speed of the adjacent upstream cell, an average speed of the lane level cell over an average speed of the adjacent downstream cell, and vehicle maneuvers identified for the road network.

14. The system of claim 10, wherein the processor controls a lane change of the host vehicle when the hazard is predicted in the downstream of a current travelling lane of the host vehicle.

15. A non-transitory computer-readable storage medium including instructions that when executed by a processor, cause the processor to:
receive vehicle data from a plurality of vehicles each equipped for computer communication, wherein each vehicle in the plurality of vehicles is travelling along a road network including a plurality of lanes, each lane in the plurality of lanes including a plurality of lane level cells, where each lane level cell includes a particular portion of a lane in the plurality of lanes;
integrate the vehicle data into the plurality of lane level cells;
for each lane level cell in the plurality of lane level cells, calculate a probability that a hazard exists with respect to the lane level cell based on the vehicle data associated with the lane level cell, the vehicle data associated with an adjacent upstream cell, and the vehicle data associated with an adjacent downstream cell; and
control a host vehicle based on the probability that the hazard exists downstream from the host vehicle.

16. The non-transitory computer-readable storage medium of claim 15, including causing the processor to partition the road network into the plurality of lane level cells.

17. The non-transitory computer-readable storage medium of claim 15, including causing the processor to identify a vehicle maneuver within each lane level cell based on the vehicle data.

18. The non-transitory computer-readable storage medium of claim 17, wherein the vehicle maneuver within each lane level cell are classified as at least one of a through maneuver, a left lane change out, a right lane change out, a right lane change, and a left lane change in.

19. The non-transitory computer-readable storage medium of claim 17, wherein calculating the probability that the hazard exists is based on a logistic regression of the vehicle data including the identified vehicle maneuvers.

20. The non-transitory computer-readable storage medium of claim 15, including causing the processor to control lateral movement of the host vehicle when the hazard is predicted in the downstream of a current travelling lane of the host vehicle.
